(19) United States
(12) Patent Application Publication
(10) Pub. No.: US 2022/0245573 A1
(43) Pub. Date: Aug. 4, 2022

(54) RISK-AWARE AND STRATEGY-ADAPTIVE CONSUMPTION PLANNING FOR PROCESS AND MANUFACTURING PLANTS

(71) Applicant: C3.ai, Inc., Redwood City, CA (US)

(72) Inventors: Zhaoxi Zhang, Palo Alto, CA (US); Sina K. Pakazad, Redwood City, CA (US); Christian S. Brown, San Francisco, CA (US); Timothy P. Holtan, Naperville, IL (US)

(21) Appl. No.: 17/665,428

(22) Filed: Feb. 4, 2022

Related U.S. Application Data
(60) Provisional application No. 63/145,937, filed on Feb. 4, 2021.

(51) Int. Cl. G06Q 10/08; G06Q 10/06; G06N 20/00

(52) U.S. Cl. CPC G06Q 10/087; G06N 20/00; G06Q 10/06315

(57) ABSTRACT

A method includes obtaining information defining multiple customer orders for one or more products over time. The method also includes using machine learning to identify one or more of the customer orders that are likely to change based on classification of the customer orders. The method further includes using machine learning to estimate one or more lengths of time that the one or more customer orders are likely to change based on regression of the customer orders. In addition, the method includes generating a consumption plan for a facility based on the one or more estimated lengths of time that the one or more customer orders are likely to change.

### CROSS-REFERENCE TO RELATED APPLICATION AND PRIORITY CLAIM

This application claims priority under 35 U.S.C. § 119(e) to U.S. Provisional Patent Application No. 63/145,937 filed on Feb. 4, 2021. This provisional application is hereby incorporated by reference in its entirety.

### TECHNICAL FIELD

This disclosure is generally directed to consumption planning systems. More specifically, this disclosure is directed to risk-aware and strategy-adaptive consumption planning for process and manufacturing plants.

### BACKGROUND

Consumption planning generally refers to the process of determining a schedule for acquiring materials to be used by a manufacturing or processing plant to produce one or more products. For example, consumption planning may involve determining how various raw materials should be acquired in order to ensure that desired quantities of various products can be produced within a given time period. Consumption planning for a plant typically involves identifying an acquisition schedule (such as one or more raw materials to be obtained, quantities of the raw materials to be obtained, and timing of the raw materials to be obtained) for the plant over a forward-looking time horizon.

### SUMMARY

This disclosure relates to risk-aware and strategy-adaptive consumption planning for process and manufacturing plants.

In a first embodiment, a method includes obtaining information defining multiple customer orders for one or more products over time. The method also includes using machine learning to identify one or more of the customer orders that are likely to change based on classification of the customer orders. The method further includes using machine learning to estimate one or more lengths of time that the one or more customer orders are likely to change based on regression of the customer orders. In addition, the method includes generating a consumption plan for a facility based on the one or more estimated lengths of time that the one or more customer orders are likely to change.

In a second embodiment, an apparatus includes at least one processing device configured to obtain information defining multiple customer orders for one or more products over time. The at least one processing device is also configured to use machine learning to identify one or more of the customer orders that are likely to change based on classification of the customer orders. The at least one processing device is further configured to use machine learning to estimate one or more lengths of time that the one or more customer orders are likely to change based on regression of the customer orders. In addition, the at least one processing device is configured to generate a consumption plan for a facility based on the one or more estimated lengths of time that the one or more customer orders are likely to change.

In a third embodiment, a non-transitory computer readable medium stores computer readable program code that when executed causes one or more processors to obtain information defining multiple customer orders for one or more products over time. The medium also stores computer readable program code that when executed causes the one or more processors to use machine learning to identify one or more of the customer orders that are likely to change based on classification of the customer orders. The medium further stores computer readable program code that when executed causes the one or more processors to use machine learning to estimate one or more lengths of time that the one or more customer orders are likely to change based on regression of the customer orders. In addition, the medium stores computer readable program code that when executed causes the one or more processors to generate a consumption plan for a facility based on the one or more estimated lengths of time that the one or more customer orders are likely to change.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting risk-aware and strategy-adaptive consumption planning for process and manufacturing plants according to this disclosure;

FIG. 2 illustrates an example device supporting risk-aware and strategy-adaptive consumption planning for process and manufacturing plants according to this disclosure;

FIG. 3 illustrates an example order with multiple order lines for use during consumption planning for process and manufacturing plants according to this disclosure;

FIG. 4 illustrates an example order change history for use during consumption planning for process and manufacturing plants according to this disclosure;

FIG. 5 illustrates an example architecture supporting risk-aware and strategy-adaptive consumption planning for process and manufacturing plants according to this disclosure;

FIG. 6 illustrates an example entity relationship diagram that may support the use of machine learning during risk-aware and strategy-adaptive consumption planning for process and manufacturing plants according to this disclosure;

FIG. 7 illustrates an example order change history related to a completed order line for use during consumption planning for process and manufacturing plants according to this disclosure;

FIG. 8 illustrates example timelines associated with performing consumption planning relative to changing orders from a customer according to this disclosure;

FIG. 9 illustrates example purchase sequences that may be associated with a customer and considered during consumption planning according to this disclosure;

FIG. 10 illustrates an example order change history related to a completed order line updated with prediction targets for use during consumption planning for process and manufacturing plants according to this disclosure;

FIG. 11 illustrates an example customized regression loss function that may be used by a machine learning model during risk-aware and strategy-adaptive consumption planning for process and manufacturing plants according to this disclosure;

FIG. 12 illustrates an example decrementing of a demand forecast based on order lines during risk-aware and strategy-adaptive consumption planning for process and manufacturing plants according to this disclosure;

FIG. 13 illustrates an example demand forecast allocation over a planning horizon during risk-aware and strategy-adaptive consumption planning for process and manufacturing plants according to this disclosure;

FIGS. 14 and 15 illustrate example results of risk-aware and strategy-adaptive consumption planning for process and manufacturing plants according to this disclosure; and

FIG. 16 illustrates an example method for risk-aware and strategy-adaptive consumption planning for process and manufacturing plants according to this disclosure.

### DETAILED DESCRIPTION

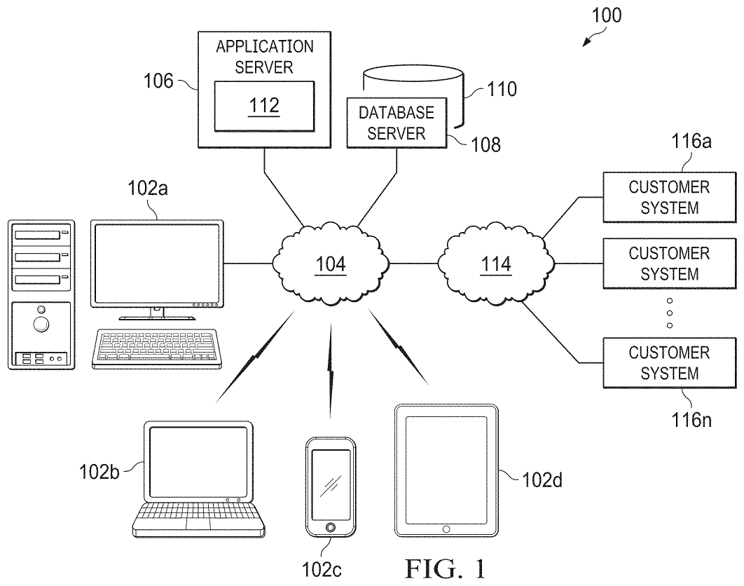

FIGS. 1 through 16, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, consumption planning generally refers to the process of determining a schedule for acquiring materials to be used by a manufacturing or processing plant to produce one or more products. For example, consumption planning may involve determining how various raw materials should be acquired in order to ensure that desired quantities of various products can be produced within a given time period. Consumption planning for a plant typically involves identifying an acquisition schedule (such as one or more raw materials to be obtained, quantities of the raw materials to be obtained, and timing of the raw materials to be obtained) for the plant over a forward-looking time horizon.

Consumption planning has traditionally been performed manually and is labor-intensive. Often times, approaches for consumption planning involve trial-and-error to adjust and fully tune an acquisition schedule. This is because these approaches commonly suffer from biases introduced by human intuition, which may not be fully reflective of reality. As a result, these approaches often fail to comprehensively consider risk, and it is difficult to adjust and adapt these approaches to moving risk targets and strategies.

This disclosure provides an apparatus, method, and computer readable medium supporting a process for consumption planning that more accurately quantifies demand uncertainty associated with customer orders and provides risk-aware and strategy-adaptive modifications to upcoming customer orders. The described approaches generate a consumption plan for a plant for a time horizon into the future. The described approaches uniquely combine customer orders and demand forecasts for the future and propose risk-aware and strategy-adaptive modifications to the upcoming customer orders. This is accomplished by leveraging certainty thresholds and asymmetric loss functions that encode the level of suitable risk by the plant. The described approaches generally involve three operations. A data-driven prediction of which upcoming customer orders are more likely to be subject to change is made, leveraging one or more certainty thresholds. If an order is deemed to be more likely to be subject to change, an order fulfillment date is predicted by following a data-driven optimization approach that relies on a piecewise asymmetric loss function. The loss function is defined to encode an adopted strategy for fulfilling customer orders by the plant. The customer orders (which include one or more modified customer orders and any non-modified customer orders) are combined with a remainder demand forecast, which is distributed over the planning horizon following a historical consumption distribution.

In this way, the described approaches for consumption planning can be performed much more quickly and with much less manual effort by plant operators or other personnel. Moreover, the described approaches enable more realistic consumption planning by intuitively encoding a level of desired risk by a plant and its planning strategies. Further, the described approaches for consumption planning can reduce or avoid biases introduced by human intuition, thereby reducing or avoiding problems associated with those biases. In addition, the described approaches can comprehensively consider risk and can adjust and adapt to moving risk targets and strategies.

Note that the approaches described below for consumption planning may be used in any number of applications. Example use cases for the described approaches may include use with chemical manufacturing or processing facilities, food processing facilities, paper or pulp manufacturing or processing facilities, and oil and gas processing facilities. In general, the approaches described below may be used in any suitable manner to support consumption planning.

FIG. 1 illustrates an example system 100 supporting risk-aware and strategy-adaptive consumption planning for process and manufacturing plants according to this disclosure. For example, the system 100 shown here can be used to support the consumption planning process described below. As shown in FIG. 1, the system 100 includes user devices 102a-102d, one or more networks 104, one or more application servers 106, and one or more database servers 108 associated with one or more databases 110. Each user device 102a-102d communicates over the network 104, such as via a wired or wireless connection. Each user device 102a-102d represents any suitable device or system used by at least one user to provide or receive information, such as a desktop computer, a laptop computer, a smartphone, and a tablet computer. However, any other or additional types of user devices may be used in the system 100.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. In some cases, the network 104 may represent an internal or private network used by an owner or operator of a process manufacturing plant.

The application server 106 is coupled to the network 104 and is coupled to or otherwise communicates with the database server 108. The application server 106 supports the consumption planning process described below. For example, the application server 106 may execute one or more applications 112 that use data from the database 110 to perform consumption planning. Note that the database server 108 may also be used within the application server 106 to store information, in which case the application server 106 may store the information itself used to perform consumption planning.

The database server 108 operates to store and facilitate retrieval of various information used, generated, or collected by the application server 106 and the user devices 102a-102d in the database 110. For example, the database server 108 may store various information related to customer product orders and other information used during consumption planning.

In this example, at least some of the information used by the application server 106 and/or stored in the database 110 may be received over at least one additional network 114 from one or more customer systems 116a-116n. For example, the network 114 may represent a public data network (such as the Internet) or other network that allows the one or more customer systems 116a-116n to provide information to and receive information from the owner or operator of a process manufacturing plant. As a particular example, the one or more customer systems 116a-116n may be used by customers to provide order information to the owner or operator of the process manufacturing plant, where that information can be used by the application server 106 to perform consumption planning.

A determined consumption plan produced by the application server 106 may be used in any suitable manner. For example, the determined consumption plan may be presented to one or more users, such as via one or more of the user devices 102a-102d. The one or more users may review the determined consumption plan, make changes to the determined consumption plan, or perform other actions using the determined consumption plan. The determined consumption plan may also be used by the application server 106 or other device to automatically order raw materials, schedule operations to be performed using the raw materials, or control operations being performed using the raw materials. In general, one or more consumption plans may be used in any suitable manner with or without user interaction.

Although FIG. 1 illustrates one example of a system 100 supporting risk-aware and strategy-adaptive consumption planning for process and manufacturing plants, various changes may be made to FIG. 1. For example, the system 100 may include any number of user devices 102a-102d, networks 104, 114, application servers 106, database servers 108, databases 110, and customer systems 116a-116n. Also, these components may be located in any suitable locations and might be distributed over a large area. In addition, while FIG. 1 illustrates one example operational environment in which consumption planning may be used, this functionality may be used in any other suitable system.

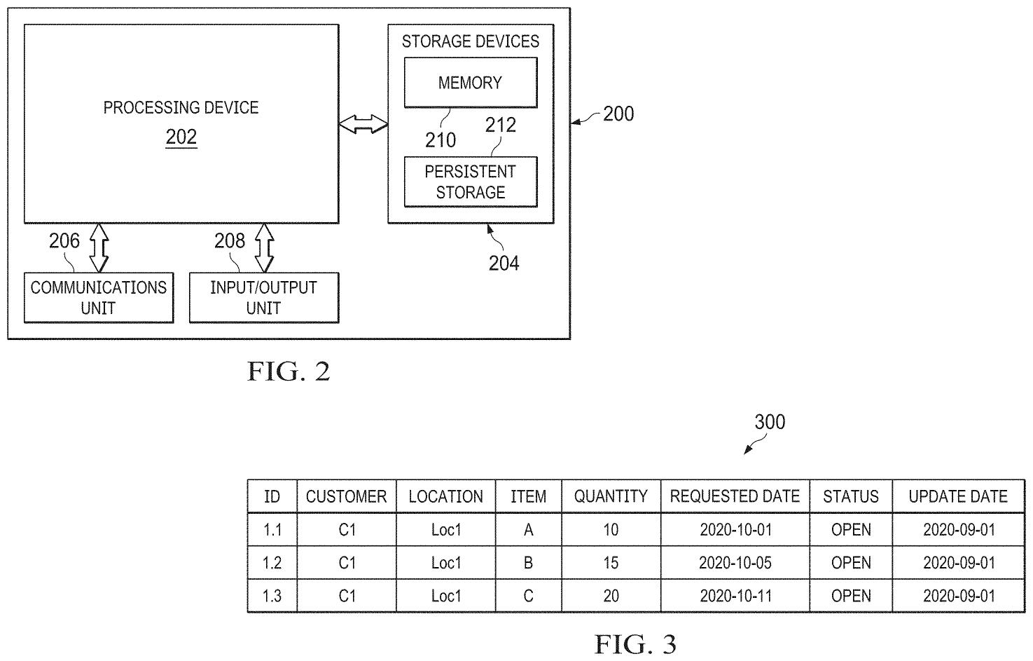

FIG. 2 illustrates an example device 200 supporting risk-aware and strategy-adaptive consumption planning for process and manufacturing plants according to this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, database server 108, or customer system 116a-116n in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104 or 114. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

Although FIG. 2 illustrates one example of a device 200 supporting risk-aware and strategy-adaptive consumption planning for process and manufacturing plants, various changes may be made to FIG. 2. For example, computing and communication devices and systems come in a wide variety of configurations, and FIG. 2 does not limit this disclosure to any particular computing or communication device or system.

The following now describes example approaches for performing risk-aware and strategy-adaptive consumption planning for process and manufacturing plants. Note that the specific details provided below are for illustration only and can vary as needed or desired. For instance, specific equations and curves are provided below for features such as a loss function and consumption plan metrics, and these equations and curves may be modified as needed or desired. For ease of explanation, it is assumed that the approaches described below are performed using the application server 106 of FIG. 1, which may be implemented using one or more instances of the device 200 of FIG. 2. However, the approaches described below may be implemented using any suitable device(s) in any suitable system(s).

Consider a manufacturing, processing, or other facility that is responsible for satisfying customer demand for multiple products. Each of multiple customers may submit one or more orders, and each order can contain one or multiple order lines associated with one or multiple products. FIG. 3 illustrates an example order 300 with multiple order lines for use during consumption planning for process and manufacturing plants according to this disclosure. As can be seen in FIG. 3, each order line represents a request for an item and contains information associated with that item. In this example, each order line includes an identification of the customer ordering an item (product), the item to be purchased or otherwise obtained by the customer, a quantity of the item requested, and a requested date by which the customer would like to obtain the item being ordered. Other information in each order line can include a customer location where the item is to be delivered, a current status of the order line, and the date that the order was created/updated. In some cases, different order lines of an order 300 can specify different items, different quantities, and/or different requested dates.

By aggregating orders across order lines for each product and date, a forward-looking demand can be estimated for the products. This anticipated demand can be referred to as “planned consumption” or a “consumption plan.” Ideally, the order lines would provide a perfect view of what future demand for the products will be. However, in reality, this is rarely the case. There are various sources of uncertainty that can prevent order lines from being taken at face value when determining planned consumption. For instance, example sources of uncertainty may include (i) additional customer orders that may be submitted within a scheduling horizon and (ii) open order lines that are subject to change by the customers within the scheduling horizon.

Regarding the first source of uncertainty above, the potential for additional customer orders to be submitted within a scheduling horizon can emphasize the importance of obtaining a consumption plan that anticipates future demand, even if the future demand has not yet been realized in the form of an open order line. To address this, a demand forecast is typically utilized. Note that various approaches for generating a demand forecast are known in the art, and other approaches are sure to be developed in the future. Any suitable technique for generating a demand forecast may be used here, and it is assumed below that a demand forecast has been generated and is available for use during consumption planning. It is also assumed below that a demand forecast is available for each product and that the demand forecast is reported at a coarser frequency than what consumption planning involves. For example, planned consumption may be needed at a daily interval, while demand forecasts may be generated or otherwise made available on a monthly basis. How the demand forecast can be utilized is described in more detail below.

The second source of uncertainty above refers to the uncertainty associated with existing open order lines. Specifically, customers may make modifications to their open orders. One common example of this involves a customer changing an order's requested date, meaning a customer may be free to bring forward or push back the requested date by which the customer would like to receive an order. In some cases, the sequence of changes to a particular customer order and corresponding order lines may be tracked using an order change history.

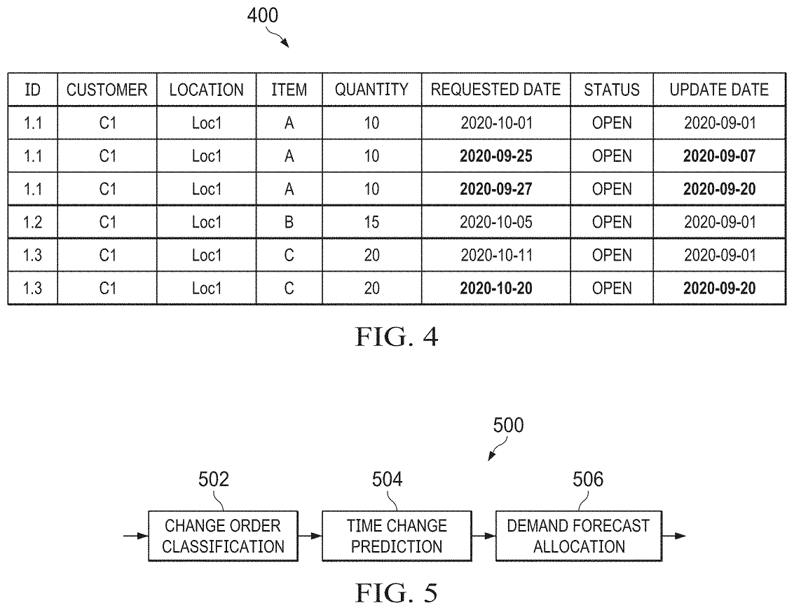

FIG. 4 illustrates an example order change history 400 for use during consumption planning for process and manufacturing plants according to this disclosure. As shown in FIG. 4, the order change history 400 identifies one or more changes that have been made to the order 300 shown in FIG. 3. In this specific example, the order change history 400 indicates that the first order line “1.1” in the order 300 has been changed twice, where each change involves altering the requested date. The order change history 400 also indicates that the third order line “1.3” in the order 300 has been changed once, again by altering the requested date. As can be seen here, uncertainty in consumption planning can arise because customers may change when specific quantities of items are requested.

Ideally, a generated consumption plan can address various sources of uncertainty, including those sources of uncertainty described above. Among other things, the ways in which these sources of uncertainty are quantified can reflect the priorities of a particular plant or business. For example, a risk-averse business may want to plan for orders earlier than anticipated, such as to account for the possibility of a customer changing a requested date to be earlier than previously requested. A less risk-averse business may want to plan for orders closer to their original requested dates. Thus, a generated consumption plan may capture the following elements. The consumption plan may provide a forward-looking anticipated demand, such as for purposes of production scheduling and supply chain management. The consumption plan may handle uncertainties associated with incomplete information and potential changes to existing information. The consumption plan may ensure that anticipated demand appropriately captures the business or plant's aversion to risk (whatever that might be). The following discussion provides an overview of a consumption planning approach to produce such a consumption plan, which is followed by more detailed discussions of aspects of the consumption planning approach.

Although FIG. 3 illustrates one example of an order 300 with multiple order lines for use during consumption planning for process and manufacturing plants and FIG. 4 illustrates one example of an order change history 400 for use during consumption planning for process and manufacturing plants, various changes may be made to FIGS. 3 and 4. For example, the information contained in the order 300 of FIG. 3 can easily vary based on factors such as the items being obtained, the quantities of the items, the dates requested, and the locations of delivery. Similarly, the information contained in the order change history 400 of FIG. 4 can easily vary based on factors such as the original order and how order lines in the original order change over time.

FIG. 5 illustrates an example architecture 500 supporting risk-aware and strategy-adaptive consumption planning for process and manufacturing plants according to this disclosure. For ease of explanation, the architecture 500 shown in FIG. 5 is described as involving the use of the application server 106 of FIG. 1, which may be implemented using one or more instances of the device 200 of FIG. 2. However, the architecture 500 may be implemented using any suitable device(s) in any suitable system(s).

As shown in FIG. 5, the architecture 500 generally includes a change order classification function 502, a time change prediction function 504, and a demand forecast allocation function 506. The change order classification function 502 generally operates to identify open orders or order lines that are likely to change over a planning horizon. In some embodiments, the determination of whether an order or order line is likely to change can be cast as a classification problem. Also, in some embodiments, the change order classification function 502 can be implemented using a trained machine learning model that uses the classification problem when determining whether each order or order line is likely to change over the planning horizon. Additional details of example embodiments of the change order classification function 502 are provided below.

The time change prediction function 504 generally operates to predict the number of days or other length of time that an open order or order line is likely to change by (for each open order or order line identified as likely to change by the change order classification function 502). In some embodiments, the determination of the length of time that an order or order line is likely to change by can be cast as a regression problem. Also, in some embodiments, the time change prediction function 504 can be implemented using a trained machine learning model that uses the regression problem when determining the length of time that an order or order line is likely to change over the planning horizon. Additional details of example embodiments of the time change prediction function 504 are provided below.

The demand forecast allocation function 506 generally operates to allocate an aggregate demand forecast over the planning horizon. The aggregate demand forecast here can be based on both (i) a demand forecast that anticipates future demand (even future demand that has not yet been realized in the form of open order lines) and (ii) existing customer orders or order lines (including those orders or order lines that are identified as being likely to change). In some embodiments, the demand forecast allocation function 506 can allocate the aggregate demand forecast based on a historical demand distribution, which represents a previous or historical distribution of demand. Additional details of example embodiments of the demand forecast allocation function 506 are provided below.

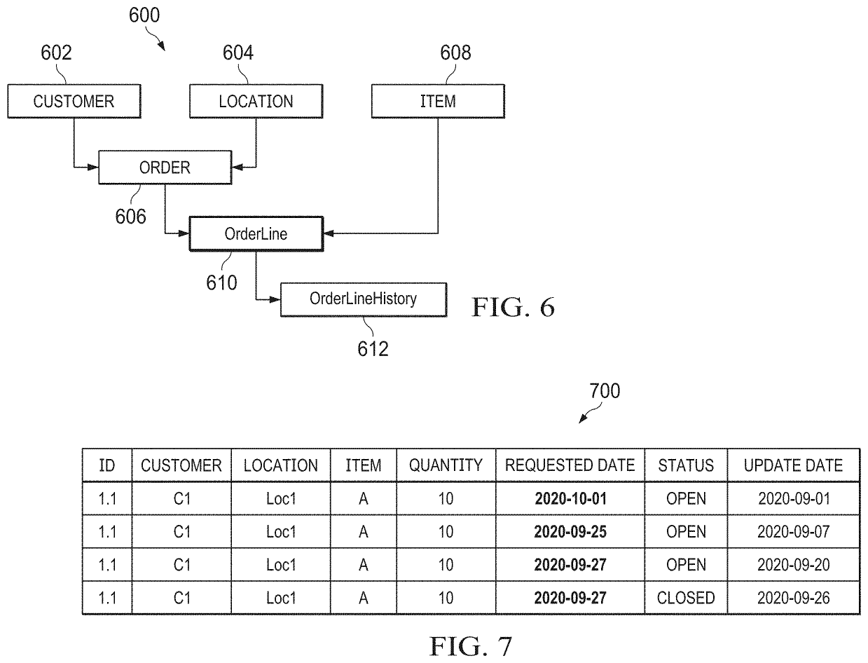

As noted above, in some embodiments, the change order classification function 502 and the time change prediction function 504 may involve casting consumption planning tasks as machine learning problems. FIG. 6 illustrates an example entity relationship diagram 600 that may support the use of machine learning during risk-aware and strategy-adaptive consumption planning for process and manufacturing plants according to this disclosure. As shown in FIG. 6, a customer 602 and a location 604 are associated with an order 606, and a product or item 608 associated with the order 606 represents an order line 610 of the order 606. Any changes to the order line 610 can be reflected or identified in an order line history 612. Note that each directed relationship represented using an arrow in FIG. 6 may represent a one-to-many relationship. In order words, the customer 602 and the location 604 may be associated with one or multiple orders 606, and each order 606 and each item 608 may be associated with one or multiple order lines 610.

In some embodiments, the functions 502-506 described above implement a consumption planning process that operates to make predictions against each order line 610, since the order lines 610 contain information about the items 608, quantities of the items 608, and timings for delivery of the items 608 needed to produce a consumption plan. Related information, such as orders 606, items 608, and/or historical changes recorded in the order line history 612, may also be valuable when making predictions. The process shown in FIG. 5 can be applied independently to each product or item 608 for which a consumption plan is needed or desired. The following discussion assumes that the architecture 500 operates using the entity relationship diagram 600 to perform consumption planning. Note, however, that other approaches (such as those using other entity relationship diagrams) may be used without departing from the scope of this disclosure.

Although FIG. 5 illustrates one example of an architecture 500 supporting risk-aware and strategy-adaptive consumption planning for process and manufacturing plants, various changes may be made to FIG. 5. For example, various functions shown in FIG. 5 may be combined, further subdivided, replicated, omitted, or rearranged and additional functions may be added according to particular needs. Although FIG. 6 illustrates one example of an entity relationship diagram 600 that may support the use of machine learning during risk-aware and strategy-adaptive consumption planning for process and manufacturing plants, various changes may be made to FIG. 6. For example, any other suitable arrangement of order-related information may be used by the architecture 500 or other architecture that supports risk-aware and strategy-adaptive consumption planning.

With respect to the change order classification function 502, the change order classification function 502 generally operates to identify which open orders 606 or order lines 610 are likely to change. The following describes how this operation can be cast into a classification problem and describes the types of features that are useful to accomplish this operation. In some embodiments, using the entity relationship diagram 600 of FIG. 6, the change order classification function 502 may operate to generate predictions as to which order lines 610 are likely to change within a given time horizon. Each order line 610 may represent a particular item 608 in a particular order 606, and each order line 610 may include specific details about the item 608, the quantity of the item 608, and the requested date for the item 608. If one or more modifications have been made to a particular order line 610, the historical changes may be recorded as part of the order line history 612.

FIG. 7 illustrates an example order change history 700 related to a completed order line for use during consumption planning for process and manufacturing plants according to this disclosure. The order change history 700 may, for example, represent information stored in the order line history 612 for a particular order line 610. The particular order change history 700 shown in FIG. 7 relates to changes made to the order line “1.1” shown in FIGS. 3 and 4. As can be seen in FIG. 7, the order change history 700 for the order line “1.1” indicates that there have now been three updates to the order line since the order line was first created/updated. The first two updates show changes being made to the order line's requested date and match the changes shown in FIG. 4, and the final update shows that the order line was fulfilled and closed (meaning the product was provided to the customer).

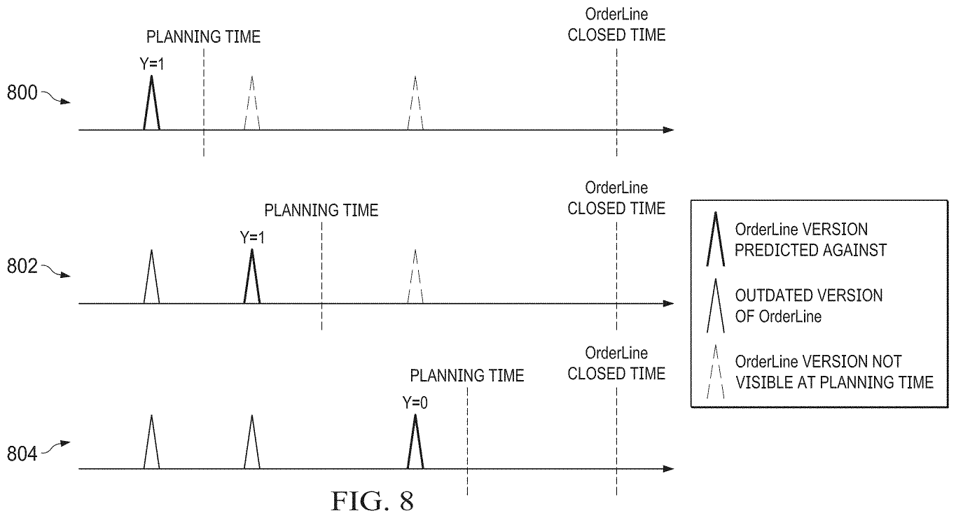

Because order lines 610 may be changed by customers, the results of a consumption planning process can vary depending on when the consumption planning process occurs relative to the changes to order lines 610. FIG. 8 illustrates example timelines 800, 802, 804 associated with performing consumption planning relative to changing orders from a customer according to this disclosure. As shown in FIG. 8, the timeline 800 is associated with performance of consumption planning at some point in time after the order line “1.1” of FIG. 7 is initially created/updated and before the changes are made to the order line. The timeline 802 is associated with performance of consumption planning at some point in time after the first update to the order line “1.1” of FIG. 7 is made and before the second change to the order line is made. The timeline 804 is associated with performance of consumption planning at some point in time after the second update to the order line “1.1” of FIG. 7 is made. In FIG. 8, creations/updates to order lines are represented as triangles on the dates that the order lines are created/updated.

As can be seen in FIG. 8, it would be useful to be able to accurately predict if each order line 610 is likely to change within a time horizon when performing consumption planning. This would provide the application server 106 with the ability to estimate whether each order line 610 is likely to change, which would then allow the application server 106 to estimate demand more accurately over the time horizon and thereby produce a more accurate consumption plan. Here, estimating whether each order line 610 is likely to change is performed using the change order classification function 502. Any order line 610 determined as being likely to change may then be analyzed (using the time change prediction function 504) to predict an estimated amount of time by which the order line 610 is likely to change.

As noted above, the change order classification function 502 may cast the estimation of whether each order line 610 is likely to change as a classification problem. In some cases, the classification problem can be used to make predictions based on the latest version of each order line 610 prior to the consumption planning time. As a result, updates to order lines 610 that occur after the planning time may not be visible and are therefore not considered as part of the consumption planning process. Also, as the planning time moves forward in time, the version of each order line 610 and its corresponding label may change. In some embodiments, an order line 610 can have a positive label if there are one or more modifications made between the planning time and the order line's closed time, and the label for the order line 610 may be negative if no more updates will be made to the order line 610 between the planning time and the order line's closed time.

It is therefore possible to train a machine learning model to perform the change order classification function 502 by providing the machine learning model with training data based on various scenarios, including those scenarios shown in FIG. 8. That is, training data having the form of the timeline 800 may be used, where this training data would indicate that changes were made after an initial order line 610 was created/updated. Training data having the form of the timeline 802 may also be used, where this training data would indicate that one or more changes were made after an initial order line 610 was created/updated and updated once. Training data having the form of the timeline 804 may further be used, where this training data would indicate that one or more changes were made after an initial order line 610 was created/updated and updated twice. Thus, all of these scenarios involving changes to order lines 610 may be used as training data for the machine learning model, and the machine learning model can be trained to estimate the likelihood of an order line 610 changing. Note that, when using each of these scenarios as training data for purposes of model training, care can be taken during feature engineering to avoid information leakage. Example features that may be used here as part of the training process are provided below. Once trained, the trained machine learning model may be placed into operation and used to identify which orders 606 or order lines 610 are likely to change within a given planning horizon. In some cases, the trained machine learning model may generate predictions using only the most-recent versions of the order lines 610.

In some embodiments, three broad categories of features may be used to train a machine learning model that implements the change order classification function 502. These broad categories of features may include (i) order-specific features that are specific to each order 606 or order line 610, (ii) time-varying features that represent aggregations formed over time windows, and (iii) static features that remain fixed over time and can be broadly applied to multiple order 606 or order lines 610.

In some cases, order-specific features may be determined by considering information specific to an order 606 or order line 610. Examples of order-specific features may include (i) a number of days or other length of time from the planning time until the requested date for the order line 610, (ii) the number of days or other length of time prior to the requested date that the customer first submitted the order line 610, and (iii) whether other order lines 610 in the same order 606 have changed.

In some cases, time-varying features may be determined as aggregations against customers over time, and these aggregations may be determined over fixed time windows ending on the consumption planning date. Examples of time-varying features may include (i) an identification of how a specific customer changes orders 606 for an item 608 in an order line 610 over a specified number of days, (ii) an identification of how all orders 606 for the item 608 in the order line 610 change over a specified number of days, (iii) an identification of how the specific customer changes all orders 606 placed within a specified number of days, and (iv) an identification of how the specific customer changes orders 606 for items 608 similar to the item 608 in the order line 610 over a specified number of days. An example of time-varying features can be illustrated by considering FIG. 4, where two changes were made to order line “1.1” on Sep. 7, 2020 and Sep. 20, 2020 and where one change was made to order line “1.3” on Sep. 20, 2020. If the consumption planning date is Oct. 1, 2020, all three changes represent changes that occurred within the previous 30 days from Oct. 1, 2020. As a result, a time-varying feature that represents the total number of order line changes by a specific customer over the previous 30 days may have a value of three for this customer.

In some cases, static features may represent features that are updated very infrequently and that can be broadly applied to multiple order lines 610. Examples of static features may include (i) an indication of how important an item 608 is for a customer, (ii) an indication of how important the customer is for the item 608, and (iii) an indication of how similar two items 608 are based on the purchasing behavior of the customer. The indication of how important the item 608 is for the customer may be expressed in one or more ways, such as a percent total volume the customer has purchased that is attributed to the specific item 608, an ascending rank by total quantity for the item 608 ordered by the customer, an average of all items 608 for the customer, and/or a standard deviation of the average for all items 608 of the customer. The indication of how important the customer is for the item 608 may be expressed in one or more ways, such as a percent total volume of the item 608 that has been purchased by the specific customer, an ascending rank by total quantity for customers that ordered the item 608, an average for all customers of the item 608, and/or a standard deviation of the average for all customers of the item 608. The indication of how similar two items 608 are based on the purchasing behavior of the customer may be expressed in one or more ways, such as when represented as an embedding.

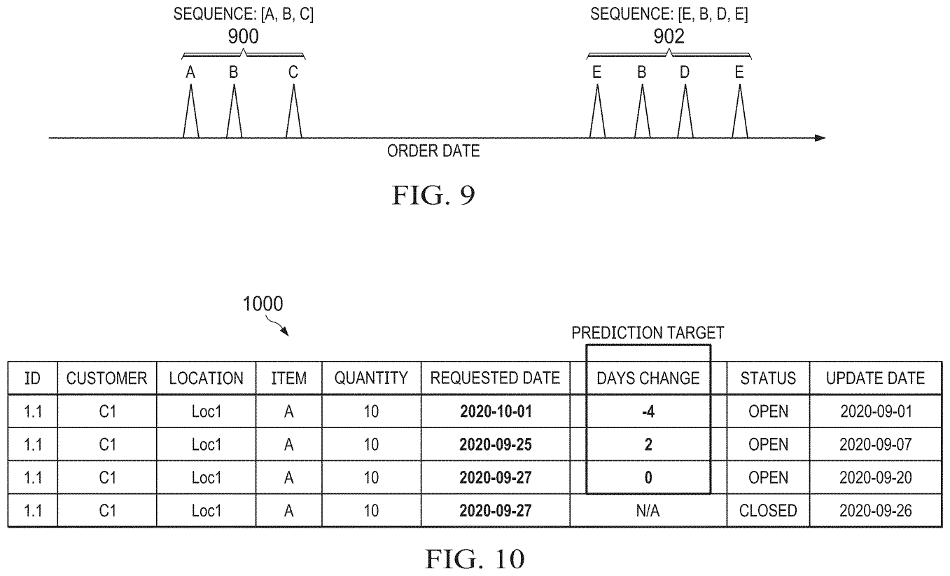

Note that the first two types of static features here may represent ratios defining the importance of a particular item to a customer and vice versa, while the third type of static feature here may represent embeddings that capture the purchasing behaviors of customers. In some cases, the embedding can be determined in the following manner. Define a “purchase sequence” of a customer as a list of items 608 purchased by the customer in quick succession. The purchasing history of the customer, represented as all unique order lines 610 submitted by the customer, may contain one or more purchase sequences (depending on the definition of “quick” succession). For instance, items 608 being purchased in a sequence of order lines 610 submitted within fourteen days of each other may be treated as a purchase sequence. FIG. 9 illustrates example purchase sequences 900, 902 that may be associated with a customer and considered during consumption planning according to this disclosure. As can be seen in FIG. 9, each purchase sequence 900 and 902 represents submissions of multiple order lines 610 that occur within a specified time period (such as fourteen days or other number of days). A purchase sequence may be viewed as a sentence, and a set of all purchase sequences across customers and time may be viewed as a corpus of text from which word embeddings can be learned. Thus, in these cases, a word may represent an item's name, and relationships between embeddings can capture whether items are typically purchased alongside one another. These embeddings may be generated in any suitable manner, such as by utilizing approaches like the Word2vec technique. Following this, an embedding for a customer can be represented as an average of all embeddings associated with items 608 contained in all order lines 610 that the customer has placed. If a customer or item does not exist, an embedding for that customer or item may be set to some initial value until sufficient data is collected to relearn the embeddings, such as when the average value of all embeddings is used. In particular embodiments, the embeddings for customers and items may be the most significant static features, and amongst the top ten global features, for a classifier (although this is not required)

Although FIG. 7 illustrates one example of an order change history 700 related to a completed order line for use during consumption planning for process and manufacturing plants, various changes may be made to FIG. 7. For example, the information contained in the order change history 700 can easily vary based on factors such as the original order, how the order line in the original order changed over time, and when the order line was closed. Although FIG. 8 illustrates one example of timelines 800-804 associated with performing consumption planning relative to changing orders from a customer, various changes may be made to FIG. 8. For example, timelines may involve any other suitable number of order line changes relative to consumption planning times. Although FIG. 9 illustrates examples of purchase sequences that may be associated with a customer and considered during consumption planning, various changes may be made to FIG. 9. For example, a customer may be associated with any number of purchase sequences (including zero purchase sequences), and each purchase sequence may involve any suitable number of order lines 610.

With respect to the time change prediction function 504, the time change prediction function 504 generally operates to predict the number of days or other length of time that an open order 606 or order line 610 is likely to change by (at least for each open order 606 or order line 610 identified as being likely to change by the change order classification function 502). The following describes how this operation can be cast into a regression problem using a similar approach as the classification problem described above. In some cases, the features used for the regression can be identical to the features used by the change order classification function 502 for classification as described above. A prediction target, which represents the number of days or other length of time from a requested date that an order line 610 is predicted to change by, may be determined in a similar fashion against the most-recent version of the order line 610.

FIG. 10 illustrates an example order change history 1000 related to a completed order line updated with prediction targets for use during consumption planning for process and manufacturing plants according to this disclosure. As can be seen in FIG. 10, the order change history 1000 represents the order change history 700 shown in FIG. 7, but the order change history 1000 also includes prediction targets that identify the length of time associated with requested changes to an order line 610. The numbers of days shown in FIG. 10 represent regression targets for which a machine learning model can be trained to estimate. Note that the “days change” value here is computed with respect to the requested date of the final closed version of the order line 610. As a result, the regression target is non-zero while updates remain, and the regression target is zero for the last update.

Note that it is unlikely that a trained machine learning model implementing a regressor can make perfect predictions. Moreover, penalties associated with having inaccurate predictions may not be symmetrical. For instance, a business or plant may only incur minor inventory holding costs for preparing an order earlier than needed, but the business or plant may incur severe serviceability penalties for completing the same order too late. To address this, the machine learning model used by the time change prediction function 504 can be trained with a customized regression loss function that reflects the business or plant's averseness to risk. In some cases, the customized regression loss function may be more severe for positive residuals, meaning higher penalties can be associated with late preparation of an order compared to early preparation of an order.

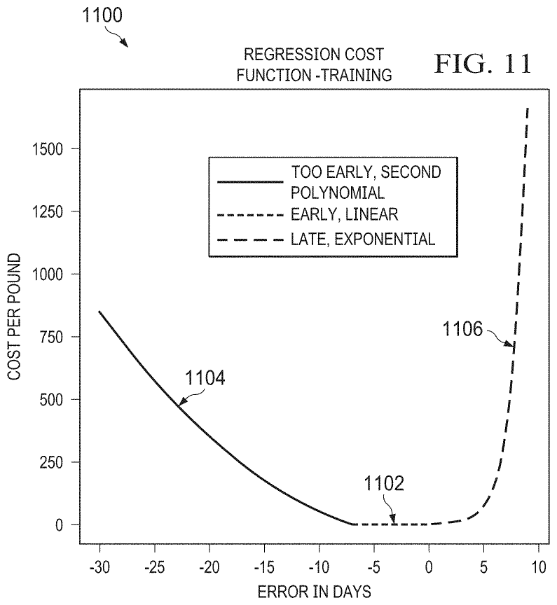

FIG. 11 illustrates an example customized regression loss function 1100 that may be used by a machine learning model during risk-aware and strategy-adaptive consumption planning for process and manufacturing plants according to this disclosure. As can be seen in FIG. 11, the customized regression loss function 1100 defines a loss in terms of a cost that varies with the number of days. A first portion 1102 of the customized regression loss function 1100 is defined immediately before a requested date for an order, which is represented by a value of zero along the horizontal axis. According to the first portion 1102 of the customized regression loss function 1100, the cost is linear and is relatively low, which indicates that a low holding cost or other small penalty may be incurred if an item 608 is produced shortly before the requested date (defined as “early”). A second portion 1104 of the customized regression loss function 1100 is defined before the first portion 1102, which means that the second portion 1104 relates to even earlier production of the item 608 (defined as “too early”). According to the second portion 1104 of the customized regression loss function 1100, the penalty for excessively early production is defined using a second-order polynomial that increases as the number of days becomes larger in absolute value terms. This indicates that larger costs may be incurred if the item 608 is produced at earlier dates relative to the requested date. A third portion 1106 of the customized regression loss function 1100 is defined after the requested date, which means that the third portion 1106 relates to positive residuals or late production of the item 608. According to the third portion 1106 of the customized regression loss function 1100, the cost is exponential, which indicates that a much higher serviceability penalty or other penalty may be imposed if the item 608 is produced after the requested date.

This type of customized regression loss function 1100 or other asymmetrical loss function can be used to capture a business or plant's averseness to risk for the regression. For example, the larger penalties for “late” conditions can encourage the regression model to push back orders to later dates infrequently, while the penalties for “too early” conditions can encourage the regression model to not predict that orders will be pushed unreasonably early (unless there is very strong reason to believe that this may occur). By leveraging a custom loss function that directly encodes a business or plant's risk averseness, the regression model is both risk-aware and adaptive to different business strategies.

Although FIG. 10 illustrates one example of an order change history 1000 related to a completed order line updated with prediction targets for use during consumption planning for process and manufacturing plants, various changes may be made to FIG. 10. For example, the information contained in the order change history 1000 can easily vary based on factors such as the original order, how the order line in the original order changed over time, and when the order line was closed. Although FIG. 11 illustrates one example of a customized regression loss function 1100 that may be used by a machine learning model during risk-aware and strategy-adaptive consumption planning for process and manufacturing plants, various changes may be made to FIG. 11. For example, a loss function may include any number of portions, and each portion may be defined in any suitable manner.

With respect to the demand forecast allocation function 506, the demand forecast allocation function 506 generally operates to produce a consumption plan, which can be done by allocating a coarsely-reported demand forecast over a planning horizon. In some cases, this can be accomplished by (i) decrementing a previously-determined demand forecast by existing order lines 610 and (ii) allocating the remaining demand forecasting budget based on historical demand distribution.

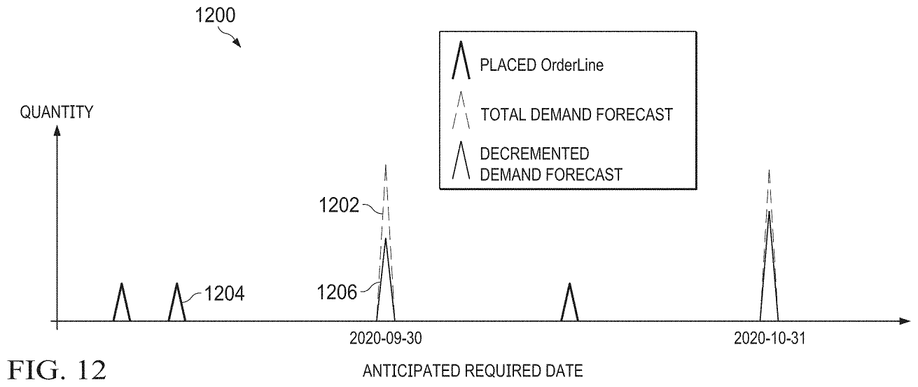

Since a demand forecast for an item 608 represents anticipated cumulative demand for that item 608 over a period of time, order lines 610 that are placed for the item 608 represent a portion of the demand forecast. As a result, the demand forecast for an item 608 can be decremented by the quantity or quantities captured by placed customer orders 606 in order to estimate the expected additional future demand for the item 608. FIG. 12 illustrates an example decrementing of a demand forecast based on order lines during risk-aware and strategy-adaptive consumption planning for process and manufacturing plants according to this disclosure. As shown in FIG. 12, a graph 1200 plots quantities of an ordered item 608 against anticipated required dates. The heights of various triangles 1202, 1204, 1206 represent the quantities of demand signals on particular dates. In this example, original demand forecasts for an item 608 are represented by triangles 1202 and may be generated or otherwise provided for different months or other time periods. Triangles 1204 represent customer order lines 610 that have been placed for the item 608, and the locations of the triangles 1204 are based on the requested dates. The quantities represented by the triangles 1202 are decremented by the quantities represented by the triangles 1204 for their respective months to yield decremented demand forecasts, each of which is represented by a triangle 1206. Each decremented demand forecast represents an estimated demand for the item 608 that is not accounted for by existing order lines 610 for the item 608. In the event that a planning horizon includes only part of a period of time for which the demand forecast is generated (such as one week for a monthly demand forecast), a proportional portion of the demand forecast can be considered for the purposes of consumption planning.

At this point, a demand forecast has been decremented to represent the quantity of additional anticipated demand beyond what has already been expressed in terms of order lines 610. However, this demand forecast is still reported coarsely over time, so the allocation of the remaining demand forecasting budget can be performed in order to prepare a consumption plan that allocates the remaining budget more granularly over the planning horizon. In some cases, this can be accomplished using the following procedure. First, the average historical distribution of consumption for an aggregation window can be determined, such as when a monthly forecast uses historical distributions prepared for each month. Second, contributions of modified order lines 610 to the historical consumption budget are assigned. This can be done to identify regions of the historical demand forecast that are captured by the existing order lines 610. Third, the demand forecast can be allocated to regions of the historical demand forecast that are not occupied by customer orders. This can be done proportionally, such as based on the difference between the historical distribution and the current quantity attributed to the order lines 610.

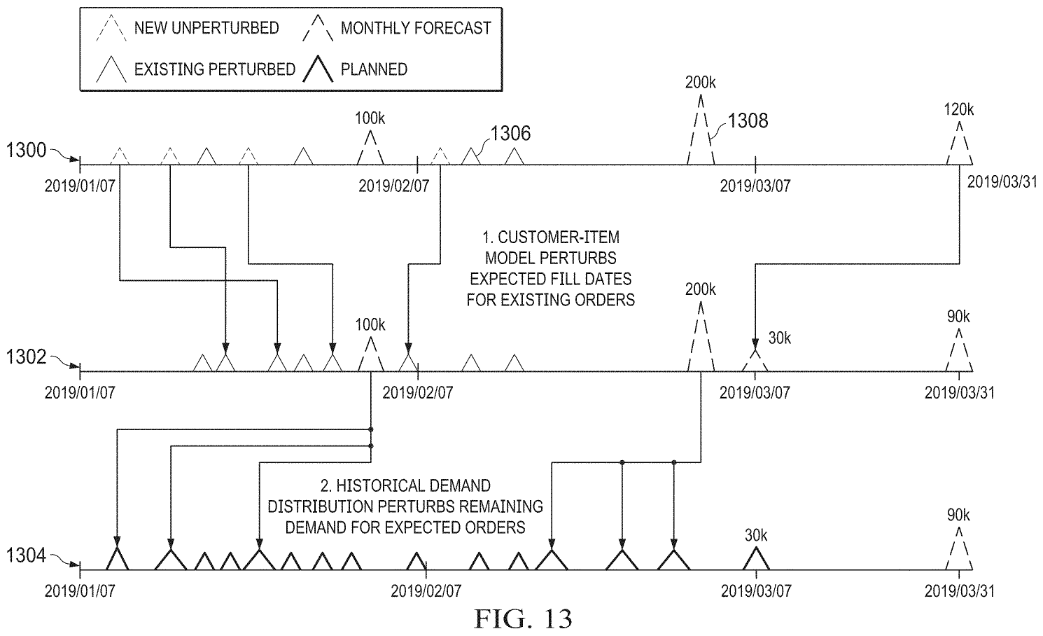

FIG. 13 illustrates an example demand forecast allocation over a planning horizon during risk-aware and strategy-adaptive consumption planning for process and manufacturing plants according to this disclosure. More specifically, FIG. 13 illustrates an example demand forecast allocation for a 60-day planning horizon starting on Jan. 7, 2019. Different plots 1300-1304 in different layers of FIG. 13 represent different steps in the allocation process, and the bottom plot 1304 represents a final consumption plan.

As shown in the top plot 1300 of FIG. 13, existing customer orders represented by triangles 1306 are overlaid with the decremented demand forecasts determined as discussed above and represented by triangles 1308. Note that the demand forecast for January 2019 is lower than that of February 2019, which is due to the fact that more orders have been placed in January (so the demand forecast for January has been decremented by a greater quantity than in February). As shown in the middle plot 1302 of FIG. 13, the demand attributed to existing order lines 610 is modified based on the outputs of the classification and regression operations described above, meaning one or more of the existing order lines 610 may be moved based on predictions generated by the change order classification function 502 and the time change prediction function 504. In this particular example, a 60-day planning horizon is used, and a portion of the demand forecast for March 2019 is positioned at the end of the planning horizon on Mar. 7, 2020. As a result, a proportional portion of the March 2019 demand forecast can be moved into the planning horizon. As shown in the bottom plot 1304 of FIG. 13, the decremented demand forecast is distributed according to a budgeted historical distribution, such as by using historical demand to distribute the decremented demand forecast. However, the demand forecast is not allocated to periods of time that are sufficiently captured by the existing order lines 610. This enables the decremented demand forecast to be satisfied while ensuring that the existing order lines 610 for current open orders 606 can also be satisfied.

Although FIG. 12 illustrates one example of decrementing of a demand forecast based on order lines during risk-aware and strategy-adaptive consumption planning for process and manufacturing plants and FIG. 13 illustrates one example of a demand forecast allocation over a planning horizon during risk-aware and strategy-adaptive consumption planning for process and manufacturing plants, various changes may be made to FIGS. 12 and 13. For example, the various demands shown in FIGS. 12 and 13 are for illustration only and can vary widely based on (among other things) the orders placed for items and the manufacturing capacity for those items.

Note that, in some cases, the overall process described above may be used to generate different consumption plans, such as different consumption plans that pull forward or push back requested dates for items 608 based on anticipated changes to order lines 610 and lengths of time associated with those anticipated changes. This raises the possibility that multiple consumption plans may be generated and compared in order to select an appropriate consumption plan for a given business or plant. Initially, it may seem reasonable to evaluate the performance of a consumption plan using typical performance metrics for regression, such as mean square error (MSE) or mean absolute percentage error (MAPE). However, this may not be appropriate in some embodiments because a consumption plan can be produced while considering a business or plant's degree of averseness to risk. As a result, two consumption plans with the same MSE value may be valued very differently by a business or plant, depending on that business or plant's preference on whether orders should generally be brought forward or pushed back in time. One possibility is to use the custom loss function that was previously used to train the regressor model as described above. However, this may not be practical if consumption plans are generated using models trained with different loss functions. Thus, in some cases, under-planning and over-planning metrics may be determined for each consumption plan and used to compare the consumption plans, which may be useful in cases where the consumption plans are produced by different risk-aware models or in other cases. In some embodiments, the under-planning and over-planning metrics may be defined as follows:

$$over - planning = \frac{\int max ( \hat{y} ( t ) - y ( t ) , 0 ) δ t}{\int y ( t ) δ t} \qquad ( 1 )$$

$$under - planning = \frac{- \int min ( \hat{y} ( t ) - y ( t ) , 0 ) δ t}{\int y ( t ) δ t} \qquad ( 2 )$$

At a high level, these metrics can be used to compare the area between (i) a curve for a consumption plan and (ii) a curve for a ground truth against a total planned volume. The numerators in Equations (1) and (2) represent the area above (over-planning) or below (under-planning) the curve, and the denominators represent the total planned volume.

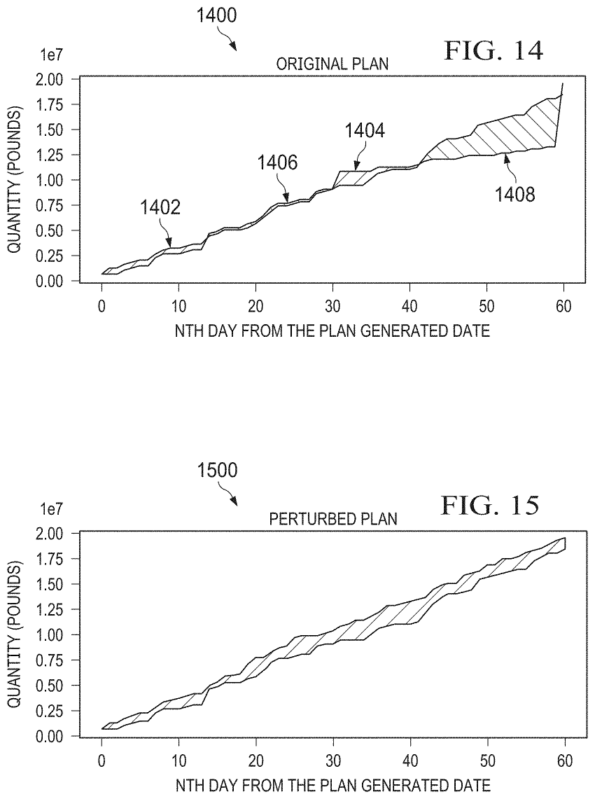

FIGS. 14 and 15 illustrate example results of risk-aware and strategy-adaptive consumption planning for process and manufacturing plants according to this disclosure. In particular, FIG. 14 illustrates an example graph 1400 showing metrics for a consumption plan produced without order modification and without demand forecast distribution. The graph 1400 represents a comparison of the baseline consumption plan against a ground truth, where the baseline consumption plan does not modify customer demand or distribute the demand. Regions 1402 and 1404 of the graph 1400 are associated with portions of the consumption plan in which over-planning occurs, and regions 1406 and 1408 of the graph 1400 are associated with portions of the consumption plan in which under-planning occurs. As can be seen here, under-planning is particularly severe in the later portion of the planning horizon, where there is likely less available customer orders and the forecasted demand is not redistributed from the end of the month. FIG. 15 illustrates an example graph 1500 showing metrics for a consumption plan produced with order modification and with demand forecast distribution using the techniques described above. The particular machine learning model(s) used to produce this consumption plan may have been optimized to reduce under-planning, which is actually eliminated in this example. This does not come at the expense of increasing over-planning too dramatically.

In some embodiments, these two measures (over-planning and under-planning) may therefore be used to construct a single performance metric that can be used to provide a single source of truth when comparing the performances of different consumption plans. The specific way in which the over-planning and under-planning metrics can be combined or otherwise used to construct a single performance metric may vary depending on the specific use case.

However one or more metrics are defined, the metrics may be used to compare different consumption plans generated using the approaches described above. The following now describes example ways in which different consumption plans can be generated. The ability to generate and compare different consumption plans allows for the performance of scenario analysis, where different consumption plans can be compared against one another and at least one of the consumption plans can be selected for storage, output, or use. In the following discussion, different consumption plans may be generated by modifying two broad types of parameters, namely (i) parameters that do not require model retraining and (ii) parameters that require model retraining.

With respect to parameters that do not require model retraining, these parameters can be modified in order to generate different consumption plans without retraining the machine learning model(s) used to perform the functions 502-504. Among other things, modifying these parameters allows consumption plans to be produced more quickly (at least compared to those that require model retraining). Examples of these parameters may include (i) a classification threshold and (ii) a prediction mask. The classification threshold refers to the threshold used by the change order classification function 502 when predicting whether an order 606 or order line 610 is likely to change. The prediction mask refers to a mask used during prediction by the time change prediction function 504. A prediction mask may be used, for instance, to avoid modifying orders 606 or order lines 610 within one or more particular time windows.

With respect to parameters that require model retraining, these parameters can be modified in order to generate different consumption plans after retraining the machine learning model(s) used to perform the functions 502-504. Among other things, modifying these parameters may be computationally expensive, but this can provide users with a greater level of control during scenario analysis. Examples of these parameters may include (i) a regression strategy, (ii) a training mask, and (iii) feature selection. The regression strategy refers to the choice of the loss function used for the regression performed by the time change prediction function 504. Different regression strategies may be used to represent different high-level strategies around averseness to risk. In some embodiments, several machine learning models with different strategies may be pre-trained for the purposes of faster feedback during scenario analysis, although this need not be the case. The training mask refers to a mask applied to data prior to model training. The training mask may be useful if there are one or more particular periods of time that the classifier or regressor machine learning model should not be trained against. The feature selection refers to the set of features used when training a machine learning model and when making predictions. Different feature sets may be considered and used, such as when features are added to or removed from a feature set and a model is retrained and used with that feature set.

Although FIGS. 14 and 15 illustrate examples of results of risk-aware and strategy-adaptive consumption planning for process and manufacturing plants, various changes may be made to FIGS. 14 and 15. For example, the values of the metrics shown in FIGS. 14 and 15 can vary based on a number of factors, such as the specific consumption plans being generated and how one or more machine learning models are trained to perform operations during the consumption planning process.

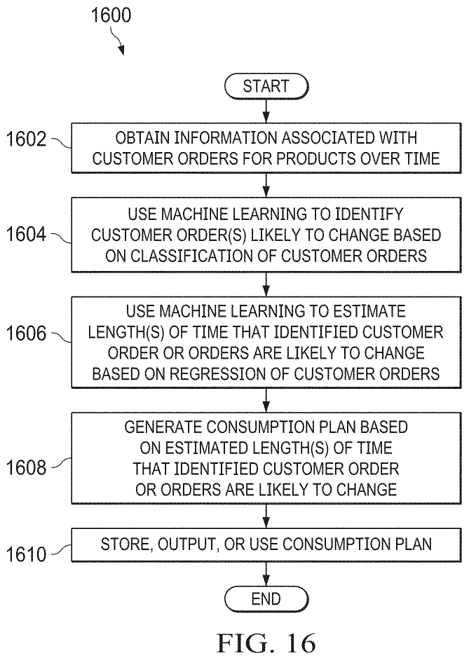

FIG. 16 illustrates an example method 1600 for risk-aware and strategy-adaptive consumption planning for process and manufacturing plants according to this disclosure. For ease of explanation, the method 1600 of FIG. 16 is described as being performed using the application server 106 of FIG. 1, which may be implemented using one or more instances of the device 200 of FIG. 2. However, the method 1600 of FIG. 16 may be performed using any suitable device(s) in any suitable system(s).

As shown in FIG. 16, information associated with customer orders is obtained at step 1602. This may include, for example, the processing device 202 of the application server 106 obtaining information identifying multiple orders 606 for various products or items 608 from various customers over time. This information may be obtained from any suitable source(s), such as from the database 110 or from one or more user devices 102a-102d.

Machine learning is used to identify one or more of the customer orders that are likely to change based on classification of the customer orders at step 1604. This may include, for example, the processing device 202 of the application server 106 using a trained machine learning model to perform the change order classification function 502. Here, the trained machine learning model may use a classification problem to classify each order line 610 as being likely to change or not likely to change within a planning horizon. In some cases, the trained machine learning model may be based on various types of features, such as one or more order-specific features, one or more time-varying features, and one or more static features.

Machine learning is used to estimate one or more lengths of time that one or more customer orders are likely to change by based on regression of the customer orders at step 1606. This may include, for example, the processing device 202 of the application server 106 using a trained machine learning model to perform the time change prediction function 504. Here, the trained machine learning model may use a regression problem to estimate the length of time that an order line 610 is likely to change, which can be performed for each order line 610 identified earlier as being likely to change within the planning horizon. In some cases, the trained machine learning model may be based on various types of features, such as one or more order-specific features, one or more time-varying features, and one or more static features. Also, in some cases, the regression may be based on a customized asymmetrical loss function that captures a particular business or plant's averseness to risk.

A consumption plan for a facility is generated based on the estimated length(s) of time that the one or more customer orders are likely to change at step 1608. This may include, for example, the processing device 202 of the application server 106 performing the demand forecast allocation function 506 to allocate demand within the planning horizon. As a particular example, this may include the processing device 202 of the application server 106 decrementing a demand forecast for each item 608 within the planning horizon based on orders 606 or order lines 610 for that item 608 within the planning horizon and allocating the decremented demand forecast within the planning horizon. The decremented demand forecast can be allocated to portions of the planning horizon not already occupied by the orders 606 or order lines 610 for the item 608 (as adjusted in previous steps). In some cases, the allocation of the decremented demand forecast can be based on historical consumption distribution.

The consumption plan can be stored, output, or used in some manner at step 1610. This may include, for example, the processing device 202 of the application server 106 outputting the consumption plan to one or more users (such as via a graphical user interface of one or more user devices 102a-102d) for approval, rejection, or modification. This may also or alternatively include the processing device 202 of the application server 106 using the consumption plan to place orders for materials, schedule operations to be performed using the materials, or control operations being performed using the materials. In general, the consumption plan may be used in any suitable manner, and all manners of use are within the scope of this disclosure. In some cases, multiple consumption plans may be generated and stored, output, or used, or one or more metrics for the multiple consumption plans may be determined and used to select at least one consumption plan for storage, output, or use.

Although FIG. 16 illustrates one example of a method 1600 for risk-aware and strategy-adaptive consumption planning for process and manufacturing plants, various changes may be made to FIG. 16. For example, while shown as a series of steps, various steps in FIG. 16 may overlap, occur in parallel, occur in a different order, or occur any number of times (including possibly zero times).

The following describes example embodiments of this disclosure that implement risk-aware and strategy-adaptive consumption planning for process and manufacturing plants. However, other embodiments may be used in accordance with the teachings of this disclosure.

In a first embodiment, a method includes obtaining information defining multiple customer orders for one or more products over time. The method also includes using machine learning to identify one or more of the customer orders that are likely to change based on classification of the customer orders. The method further includes using machine learning to estimate one or more lengths of time that the one or more customer orders are likely to change based on regression of the customer orders. In addition, the method includes generating a consumption plan for a facility based on the one or more estimated lengths of time that the one or more customer orders are likely to change.

In a second embodiment, an apparatus includes at least one processing device configured to obtain information defining multiple customer orders for one or more products over time. The at least one processing device is also configured to use machine learning to identify one or more of the customer orders that are likely to change based on classification of the customer orders. The at least one processing device is further configured to use machine learning to estimate one or more lengths of time that the one or more customer orders are likely to change based on regression of the customer orders. In addition, the at least one processing device is configured to generate a consumption plan for a facility based on the one or more estimated lengths of time that the one or more customer orders are likely to change.

In a third embodiment, a non-transitory computer readable medium stores computer readable program code that when executed causes one or more processors to obtain information defining multiple customer orders for one or more products over time. The medium also stores computer readable program code that when executed causes the one or more processors to use machine learning to identify one or more of the customer orders that are likely to change based on classification of the customer orders. The medium further stores computer readable program code that when executed causes the one or more processors to use machine learning to estimate one or more lengths of time that the one or more customer orders are likely to change based on regression of the customer orders. In addition, the medium stores computer readable program code that when executed causes the one or more processors to generate a consumption plan for a facility based on the one or more estimated lengths of time that the one or more customer orders are likely to change.

Any single one or any suitable combination of the following features may be used with the first, second, or third embodiment. The classification of the customer orders and the regression of the customer orders may both be based on (i) one or more order-specific features of the customer orders, (ii) one or more time-varying aggregations of the customer orders, and (iii) one or more static features each associated with multiple ones of the customer orders. The one or more static features may include indications of how similar different products are based on purchasing behaviors of one or more customers, where the purchasing behaviors may be captured as embeddings and where each embedding is generated using words that represent products and sentences that represent purchase sequences of products by the one or more customers. The regression of the customer orders may be based on a customized asymmetrical loss function that captures averseness to risk for the regression. The consumption plan may be generated by decrementing a demand forecast based on the customer orders and the one or more estimated lengths of time that the one or more customer orders are likely to change and allocating the decremented demand forecast over a planning horizon. The decremented demand forecast may be allocated over the planning horizon by allocating the decremented demand forecast to periods of time within the planning horizon that are not associated with the customer orders. Multiple consumption plans may be generated, and over-planning and under-planning metrics may be used to compare the multiple consumption plans.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrases “at least one of” and “one or more of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining information defining multiple customer orders for one or more products over time;
using machine learning to identify one or more of the customer orders that are likely to change based on classification of the customer orders;
using machine learning to estimate one or more lengths of time that the one or more customer orders are likely to change based on regression of the customer orders; and
generating a consumption plan for a facility based on the one or more estimated lengths of time that the one or more customer orders are likely to change.

2. The method of claim 1, wherein the classification of the customer orders and the regression of the customer orders are both based on (i) one or more order-specific features of the customer orders, (ii) one or more time-varying aggregations of the customer orders, and (iii) one or more static features each associated with multiple ones of the customer orders.

3. The method of claim 2, wherein:
the one or more static features comprise indications of how similar different products are based on purchasing behaviors of one or more customers; and
the purchasing behaviors are captured as embeddings, each embedding generated using words that represent products and sentences that represent purchase sequences of products by the one or more customers.

4. The method of claim 1, wherein the regression of the customer orders is based on a customized asymmetrical loss function that captures averseness to risk for the regression.

5. The method of claim 1, wherein generating the consumption plan comprises:
decrementing a demand forecast based on the customer orders and the one or more estimated lengths of time that the one or more customer orders are likely to change; and
allocating the decremented demand forecast over a planning horizon.

6. The method of claim 5, wherein allocating the decremented demand forecast over the planning horizon comprises allocating the decremented demand forecast to periods of time within the planning horizon that are not associated with the customer orders.

7. The method of claim 1, further comprising:
generating multiple consumption plans; and
using over-planning and under-planning metrics to compare the multiple consumption plans.

8. An apparatus comprising:
at least one processing device configured to:
obtain information defining multiple customer orders for one or more products over time;
use machine learning to identify one or more of the customer orders that are likely to change based on classification of the customer orders;
use machine learning to estimate one or more lengths of time that the one or more customer orders are likely to change based on regression of the customer orders; and
generate a consumption plan for a facility based on the one or more estimated lengths of time that the one or more customer orders are likely to change.

9. The apparatus of claim 8, wherein the classification of the customer orders and the regression of the customer orders are both based on (i) one or more order-specific features of the customer orders, (ii) one or more time-varying aggregations of the customer orders, and (iii) one or more static features each associated with multiple ones of the customer orders.

10. The apparatus of claim 9, wherein:
the one or more static features comprise indications of how similar different products are based on purchasing behaviors of one or more customers; and
the purchasing behaviors are captured as embeddings, each embedding generated using words that represent products and sentences that represent purchase sequences of products by the one or more customers.

11. The apparatus of claim 8, wherein the regression of the customer orders is based on a customized asymmetrical loss function that captures averseness to risk for the regression.

12. The apparatus of claim 8, wherein, to generate the consumption plan, the at least one processing device is configured to:
decrement a demand forecast based on the customer orders and the one or more estimated lengths of time that the one or more customer orders are likely to change; and
allocate the decremented demand forecast over a planning horizon.

13. The apparatus of claim 12, wherein, to allocate the decremented demand forecast over the planning horizon, the at least one processing device is configured to allocate the decremented demand forecast to periods of time within the planning horizon that are not associated with the customer orders.

14. The apparatus of claim 8, wherein the at least one processing device is further configured to:
generate multiple consumption plans; and
use over-planning and under-planning metrics to compare the multiple consumption plans.

15. A non-transitory computer readable medium storing computer readable program code that when executed causes one or more processors to:
obtain information defining multiple customer orders for one or more products over time;
use machine learning to identify one or more of the customer orders that are likely to change based on classification of the customer orders;
use machine learning to estimate one or more lengths of time that the one or more customer orders are likely to change based on regression of the customer orders; and
generate a consumption plan for a facility based on the one or more estimated lengths of time that the one or more customer orders are likely to change.

16. The non-transitory computer readable medium of claim 15, wherein the classification of the customer orders and the regression of the customer orders are both based on (i) one or more order-specific features of the customer orders, (ii) one or more time-varying aggregations of the customer orders, and (iii) one or more static features each associated with multiple ones of the customer orders.

17. The non-transitory computer readable medium of claim 16, wherein:
the one or more static features comprise indications of how similar different products are based on purchasing behaviors of one or more customers; and
the purchasing behaviors are captured as embeddings, each embedding generated using words that represent products and sentences that represent purchase sequences of products by the one or more customers.

18. The non-transitory computer readable medium of claim 15, wherein the regression of the customer orders is based on a customized asymmetrical loss function that captures averseness to risk for the regression.

19. The non-transitory computer readable medium of claim 15, wherein the computer readable program code that when executed causes the one or more processors to generate the consumption plan comprises:
computer readable program code that when executed causes the one or more processors to:
decrement a demand forecast based on the customer orders and the one or more estimated lengths of time that the one or more customer orders are likely to change; and
allocate the decremented demand forecast over a planning horizon.

20. The non-transitory computer readable medium of claim 19, wherein the computer readable program code that when executed causes the one or more processors to allocate the decremented demand forecast over the planning horizon comprises:
computer readable program code that when executed causes the one or more processors to allocate the decremented demand forecast to periods of time within the planning horizon that are not associated with the customer orders.
